(19) United States
(12) Patent Application Publication
(10) Pub. No.: US 2016/0148517 A1
(43) Pub. Date: May 26, 2016

(54) TALKING NOTEBOOK WITH PROJECTION

(71) Applicant: Ali Mohammad Bujsaim, Dubai (AE)

(72) Inventors: Ali Mohammad Bujsaim, Dubai (AE); Awad Al-Khalaf, Sharjah (AE); Anas Youssef Boubas, Santa Clara, CA (US)

(21) Appl. No.: 15/010,514

(22) Filed: Jan. 29, 2016

Related U.S. Application Data
(63) Continuation-in-part of application No. 13/443,458, filed on Apr. 10, 2012.
(60) Provisional application No. 61/473,890, filed on Apr. 11, 2011.

(51) Int. Cl. G09B 5/02; G06F 3/0481; G06F 3/14

(52) U.S. Cl. CPC G09B 5/02; G06F 3/1423; G06F 3/04817

(57) ABSTRACT

A talking notebook with projection includes a notebook that allows a user to take notes and press on a page to have words read aloud and a screen which is able to be used in conjunction with the notebook. The screen is able to be embedded with the notebook, or the screen is a separate device such as a tablet. The screen is able to play videos and provide other interactivity with the notebook. The talking notebook is also able to project content to a board such as a digital classroom board. By projecting content to a board, the content of the talking notebook is able to be shared easily with many people.

### RELATED APPLICATION

This application is a continuation-in-part application of co-pending U.S. patent application Ser. No. 13/443,458, filed on Apr. 10, 2012, and titled “PAPER-BASED TOUCH BOOK,” which claims priority under 35 U.S.C. §119(e) of the co-pending, co-owned U.S. Provisional Patent Application No. 61/473,890, filed Apr. 11, 2011, and titled “PAPER BASED TOUCH BOOK” which is also hereby incorporated by reference in its entirety.

### FIELD OF THE INVENTION

The present invention relates to the field of books. More specifically, the present invention relates to interactive touch books.

### BACKGROUND OF THE INVENTION

People have been trying to improve paper books for a very long time. Interactive books such as books with designated buttons that play music have been developed for children. Additionally, reading systems that encourage children to read utilize a specialized pen with an infrared camera that is able to read information and present audio dialogue. However, these interactive books have significant drawbacks such as expense.

### SUMMARY OF THE INVENTION

A system for recognizing touch on paper-based books is described herein. Two factors are recognized by the system for any touch made on any of the papers constituting the book. The first recognized factor is the position of the touch on the paper being touched. The second factor is the identification of the page being touched. Using these two recognized factors, an embedded microprocessor runs a stored procedure as a response to a touch, multiple touches or touch gestures. As an example, the response includes playing a stored sound file through speakers.

### BRIEF DESCRIPTION OF THE DRAWINGS

FIG. 1 illustrates a side view of a paper-based touch book according to some embodiments.

FIG. 2 illustrates a cross-section view of the paper-based touch book according to some embodiments.

FIG. 3 illustrates a flowchart of a method of utilizing the paper-based touch book according to some embodiments.

FIG. 4 illustrates a flowchart of a method of determining which information to play according to some embodiments.

FIG. 5 illustrates a view of a paper-based touch book using a removable cover according to some embodiments.

FIG. 6 illustrates a view of a replaceable paper-based touch booklet according to some embodiments.

FIG. 7 illustrates a view of a talking book/cover with a screen according to some embodiments.

FIG. 8 illustrates an exemplary talking book/cover with a screen according to some embodiments.

FIG. 9 illustrates a view of a talking notebook according to some embodiments.

FIG. 10 illustrates an exemplary digital notebook according to some embodiments.

FIG. 11 illustrates an exemplary digital note taking system with a textbook according to some embodiments.

FIG. 12 illustrates a digital note taking device integrated with a digital classroom board according to some embodiments.

FIG. 13 illustrates a diagram of interacting with the board according to some embodiments.

FIG. 14 illustrates an exemplary digital board according to some embodiments.

FIG. 15 illustrates a flowchart of a method of adjusting sensors of a talking book device according to some embodiments.

### DETAILED DESCRIPTION OF THE PREFERRED EMBODIMENT

The paper-based touch book includes four main subsystems or parts. The first is a sensory system. The second is a microprocessing system that is able to include a memory. The third is a response system also referred to as an actuators system. The fourth is standard, labeled paper.

The sensory system combines two sensory tasks. The first is sensing the positions of the touch being made by the user. This is able to include the starting position of the touch-down, the duration of the touch, the path the touch's motion follows (in case the touch moves), and the position of the touch-up. Multiple touches (e.g. capacitive touch sensing) are able to be sensed, whether made simultaneously or sequentially. The second task is sensing the page being touched. The Page Identification Sensor (PIS) senses the label present in the paper to determine which page was touched. This determination process is able to be done in any of several ways. One way is counting the labels present in proximity to the PIS. Given that book pages cannot be reordered, the front-most page is able to be then determined from this count value. It is then assumed that the user touches the front-most page. Another way is reading unique labels on each of the pages present in proximity to the PIS. A precedence scheme among the labels is defined so that the page with highest precedence is assumed to be the top-most page, and hence the page being touched.

The Microprocessor System (MS) is a simple embedded processing system. The input to the MS comes from the sensory system and the output goes to a response system. The main function performed by the MS is running a stored procedure whenever a touch is detected by the sensory system. This is able to include retrieving sound files corresponding to the part of the page being touched. In another example, a tactile response is able to be implemented (e.g. for deaf people). In yet another example, a set of system states is able to be defined, and the MS sets the system at a different state depending on the current state and the input received from the sensory system. A specific example of this is able to be defined as follows. State one corresponds to a masculine voice. State two corresponds to a feminine voice. A touch detected by a sensory system at a predefined location results in the MS changing the state of the system to state one in case it is in state two, or to state two in case it is in state one. Whenever a touch is made on printed text, the text is read by a masculine voice if the system is in state one, or by a feminine voice if the system is in state two. In addition to a microprocessor, the MS is able to include a memory for uses such as storing data and/or sound files.

In one basic form, the Response System (RS) is a speaker system that plays out the sound streamed from the MS. In other more advanced forms, the RS makes physical responses such as flipping the page of the book, moving a picture in the book (e.g. rotating a picture wheel on a page) or popping out a 3-dimensional figure in a pop-up book. The implementation of flipping, moving or popping out is able to be any mechanical implementation such as an automated mechanical arm/lever to turn the page or a rotating wheel to move items.

The papers constituting the book are exactly the same as standard paper used in the printing industry. That is, they are usually made from cellulose or other fibers, or sometimes from recycled fibers. In some embodiments, enhancing material is added to the paper when the paper is being generated to enable touches being sensed through many sheets of paper. In addition to the material being variable, the thickness is also variable. However, in some embodiments, the papers are labeled by a labeling scheme compatible with the PIS used. Various labeling schemes are able to be used. One such scheme is the use of Radio Frequency Identifier (RFID) tag for each page (e.g. by embedding or affixing tags on each page). In the specific example, the PIS would be an RFID reader that is able to recognize which of the RFID tags are present in close proximity. Each RFID tag corresponds to a paper, and the MS is able to then identify the touched page. Another way of identifying a page is by printing a visible or invisible QR barcode on the pages near the binding area. A small camera or infra-red camera mounted at or near that location is then able to capture the barcode of the two top facing pages.

Another labeling scheme is able to be the use of punctures in the pages. In the specific example, if the first page has n punctures, the next page has n-1 punctures, and the missing puncture is covered when it is present. By counting the uncovered punctures, the PIS identifies the top-most page. A third example of the labeling scheme is using a partially reflective label on each of the papers. The label would reflect a percentage of one type of electromagnetic wave passing through it. If two labels are present above each other, their reflection is accumulated. PIS is able to send an electromagnetic pulse through the labels and detect the amount of reflection being made. The detected amount of reflection is then divided by the reflection factor of the labels in order to calculate the number of labels present. This counting method is able to be used to determine how many pages are present, and hence the top-most page. Other scanning or detection methods are able to be implemented to determine which page a user is pointing to. For example, a scanning system is used to scan and detect text on a page through pages (e.g. the scan goes through several pages and detects the text on a page that does not have an additional page on top of it, thus indicating the page the user is reading), and based on the scan, the scanning system is able to determine which page the user is pointing to. In another example, a scanning system detects a user's finger and the text below the user's finger to determine the page the user is on. In yet another example, a scanning system is able to detect page numbers by scanning through pages to determine the page currently being viewed.

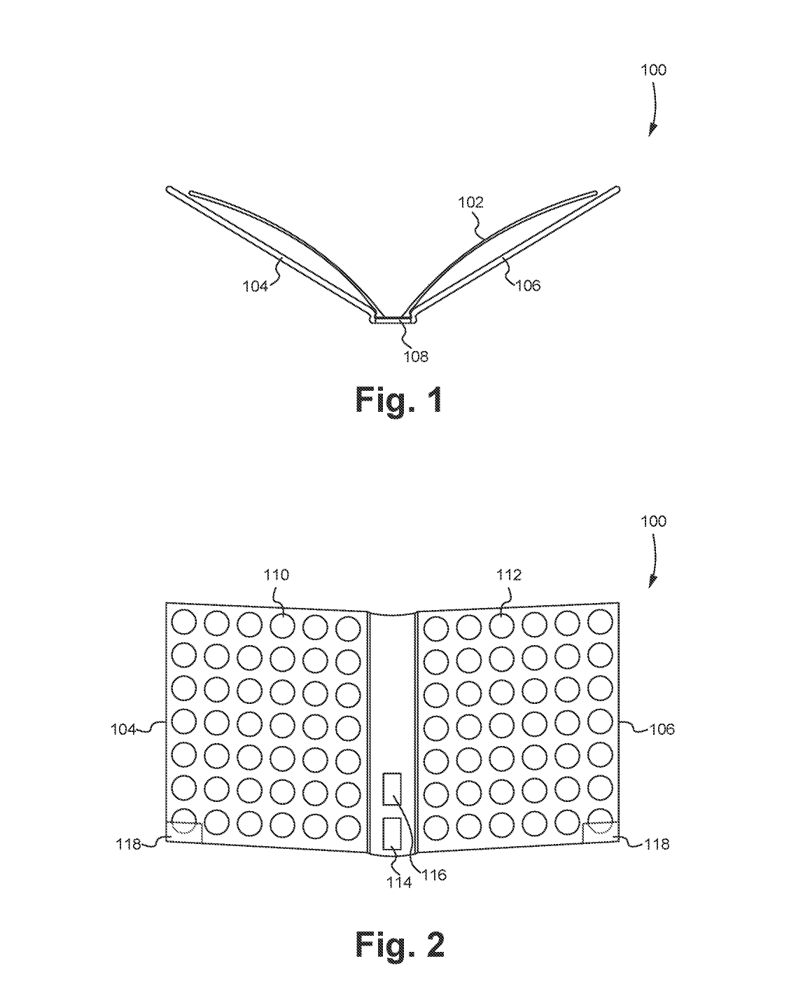

FIG. 1 illustrates a side view of a paper-based touch book according to some embodiments. The paper-based touch book 100 includes pages 102, a front cover 104, a back cover 106 and a binding 108. In some embodiments, the pages 102 are labeled. The front cover 104 includes a first embedded sensory system, and the back cover 106 includes a second embedded sensory system. The binding 108 includes an embedded microprocessing system and an embedded response system. In some embodiments, the embedded components are located anywhere in the cover, for example, instead of the binding, in the back cover.

FIG. 2 illustrates a cross-section view of the paper-based touch book according to some embodiments. The paper-based touch book 100 includes a first embedded sensory system 110 in the front cover 104 and a second embedded sensory system 112 in the back cover 106. The first sensory system 110 and the second sensory system 112 are able to be one system. The first sensory system 110 and the second sensory system 112 are able to utilize any type of sensor. In some embodiments, the first sensory system 110 and the second sensory system 112 are one sensor or are each one sensor such as a capacitive touch glass panel. In some embodiments, the first embedded sensory system 110 and the second embedded sensory system 112 each include several sensors to determine a location or position of the page being touched and a PIS for determining the page touched. Speakers 118 are also included in one or both of the covers or elsewhere in the book 100. The embedded microprocessing system 114 and the embedded response system 116 are included in the binding or elsewhere in the book 100.

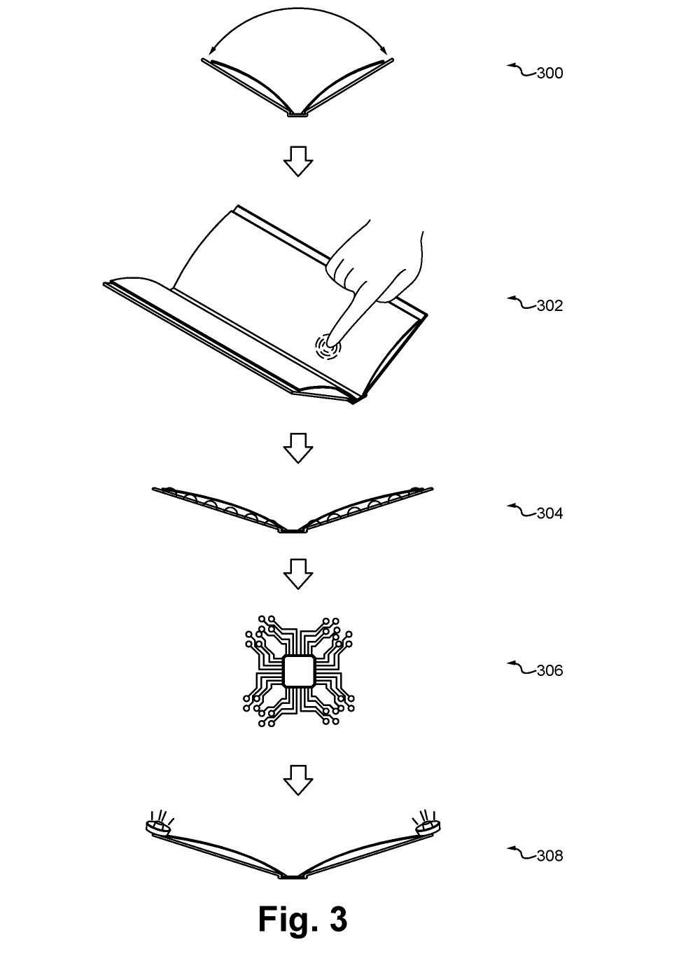

FIG. 3 illustrates a flowchart of a method of utilizing the paper-based touch book according to some embodiments. In the step 300, a user opens the book. In the step 302, the user touches a page with his finger. In the step 304, the sensors in the cover sense the user's touch, and the page is determined. In the step 306, the microprocessor retrieves an audio file corresponding to the location of the touch and the page. The audio file is able to be any type of audio file such as .au, .wav or .mp3. In the step 308, speakers play the audio file. In some embodiments, fewer or additional steps are implemented. In some embodiments, the order of the steps is modified.

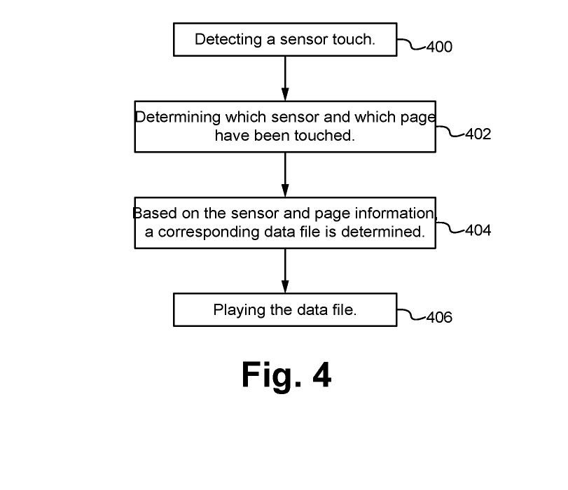

FIG. 4 illustrates a flowchart of a method of determining which information to play according to some embodiments. In the step 400, a sensor touch is detected. In the step 402, the microprocessor determines which sensor and which page was touched. In the step 404, based on the sensor and page information, a corresponding data file such as an audio file is determined. The corresponding data file is able to be determined using a data structure such as a look up table or any other structure to link the sensor information and page information with the data file. In the step 406, the data file is played (e.g. a sound recording is played through speakers). In some embodiments, fewer or additional steps are implemented. In some embodiments, the order of the steps is modified.

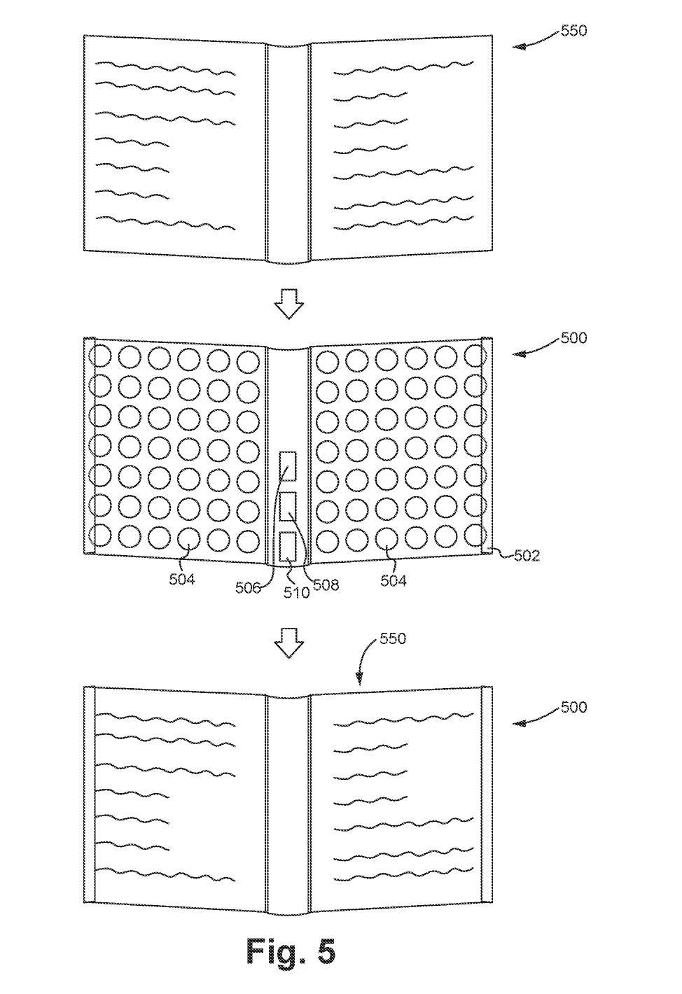

FIG. 5 illustrates a view of a paper-based touch book using a removable cover according to some embodiments. A removable cover 500 includes similar components to the paper-based touch book 100 to enable playback of audio recordings in conjunction with viewing a book. The removable cover 500 includes one or more sets of sensors 504, a microprocessing system 506, a response system 508 and one or more speakers 510. In some embodiments, the removable cover 500 includes a folded edge 502 to help secure the book 550 in place. The removable cover 500 slides onto or receives a book 550, so that the user is able to read and receive audio information about the book 550. The removable cover 500 is used by sliding the cover 500 onto the book 550. The book 550 is able to secured within the cover in any manner such as clips, sleeves, magnets or any other mechanism. For example, bringing the book into close proximity to the removable cover would cause a magnetic field to destabilize except in a specific location and alignment. This is made possible by specially arranging the magnets in the removable cover and the binding of the book. The effect is that the book would snatch into place and align correctly in a precise manner without the user's attention. The removable cover 500 then determines the title and/or content of the book 550. In some embodiments, the removable cover 500 determines the title and/or content of the book 550 automatically (e.g. by scanning an RFID using an embedded RFID reader). In some embodiments, the user inputs the book information (e.g. selects a book title from a list presented on the cover). Once the book 550 is detected, the user is able to use the cover 500 similar to the paper-based touch book 100. The user is able to press a location on a page and the sensors in the cover 500 will determine where on the page and which page was pressed, and then play the corresponding audio clip. As described above, any number of implementations are able to be used to determine the page being pressed. In this embodiment, users are able to incorporate completely unmodified books with the cover 500 and receive an interactive experience.

The paper-based touch book is able to be used with all types of books, languages and subjects. Additionally, other forms of media are able to be used as touch media with supplemental audio, such as magazines and newspapers. Although the touch book has been described as a paper-based touch book, any material is able to be used for the pages such as plastic. In some embodiments, the paper-based touch book is usable without a device such as a pen (e.g. the user uses his finger), and in some embodiments, the book is usable with an additional device. In some embodiments, by pressing a location on a page causes the book to read the text pressed, and in some embodiments supplemental information not available in the written text is played to the user. For example, if a user is reading a book about cats, and the user presses the picture of the cat, a “meow” sound is played.

To utilize the paper-based touch book, a user reads a book as usual; however, to interact with the book, a user presses a location on a page of the book, and the book responds (e.g. plays back an audio clip). For example, a child presses text on the page, and the book reads the text to the child.

In operation, the paper-based touch book is excellent in engaging kids in the learning process by bringing interactivity to traditionally printed books. The paper-based touch book makes it easier for the blind to self-learn reading by touching, since the blind are able to receive immediate vocal feedback to their touch. The paper-based touch book also helps those who learn new languages to improve on their accent. The paper-based touch book is able to be manufactured from inexpensive material and is able to be used in poor areas as an inexpensive alternative to computer systems designed to improve the learning process.

The paper-based touch book applies a new technology combining the use of waves within the radio frequency with the technology of touch sensibility through the electrical capacitive projection. In this way, the touch sensibility will include each paper of the book without using expensive materials or making the papers thicker. The book, to a great extent, will be at the same size and thickness, and the cost is low as compared to other technologies.

Although the paper-based touch book has been described in terms of a bound book, the technology is able to be implemented with non-bound sheets including unordered non-bound sheets. For example, individual sheets are placed on a cover with a sensor, and the sensor is able to detect the page using an implementation described herein or any other implementation.

In some embodiments, a device to sense presses on a page is a tablet device (e.g. iPad®), smart phone (e.g. iPhone®) or any other computing device with a sensor. For example, a user places a page on the device, and then is able to receive additional information regarding the page or have parts of the page communicated to them similarly to the paper-based touch book. The device is able to determine which page or pages are placed on the device in any manner, for example, the tag recognition described herein. Once the device recognizes the page or pages, the device is able to sense touches by the user on the page.

### Replaceable Paper-Based Touch Booklet

Similar to that which is described in FIG. 5, a talking book is able to be implemented with replaceable material (e.g., booklets) that go in the talking book cover. For example, material is able to be placed within the talking book cover. The talking book cover is able to secure the material within the cover in any manner such as using magnetic sheet-strips which secure and align the material in place. For example, the material has metal strips, or metal strips (e.g. detachable clips) are able to be attached to the material which are then able to be attached (e.g., magnetically) with the magnets contained within/on the talking book cover. In another example, the material includes metal or other attachable implementations. Additionally, the talking book cover includes capabilities of determining what material is attached to the cover. For example, the material includes an RFID tag and the talking book cover includes an RFID reader which can read the RFID tag to determine the material (e.g., the talking book cover also includes a memory storing content and associated identification information which is compared based on the read RFID tag information). In another example, the talking book cover includes a camera/scanner which is capable of recognizing a tag, a code and/or text of the inserted material. Any other ways of detecting the inserted material are possible.

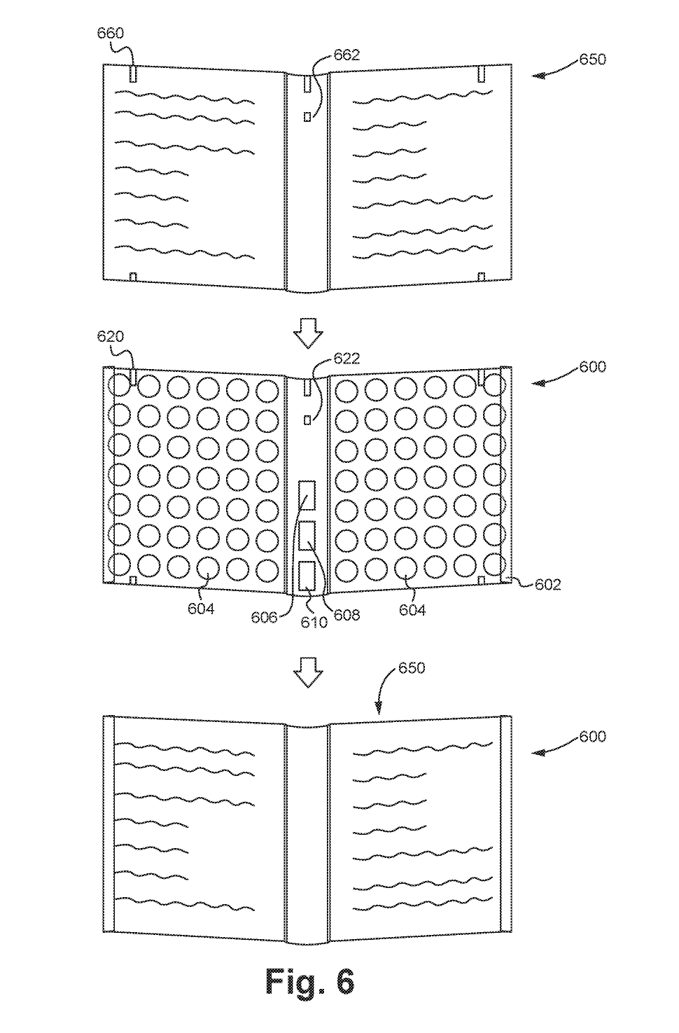

FIG. 6 illustrates a view of a replaceable paper-based touch booklet according to some embodiments. A cover 600 includes similar components to the paper-based touch book 100 to enable playback of audio recordings in conjunction with viewing a book/booklet. The cover 600 includes one or more sets of sensors 604, a microprocessing system 606, a response system 608 and one or more speakers 610. In some embodiments, the cover 600 includes a front flap, a back flap and a binding between the two, similar to a standard hardcover book. In some embodiments, the cover 600 includes a folded edge 602 to help secure the booklet 650 in place. The cover 600 slides onto or receives a booklet 650, so that the user is able to read and receive audio information about the booklet 650. The cover 600 is used by sliding the cover 600 onto the booklet 650 or attaching the booklet 650 to the cover 600. The booklet 650 is able to be secured within the cover in any manner such as clips, sleeves, magnets or any other mechanism. For example, bringing the book into close proximity to the removable cover would cause a magnetic field to destabilize except in a specific location and alignment. In another example, metal clips 660 on the booklet 650 align with the magnets 620 in the cover 600. The effect is that the book would snatch into place and align correctly in a precise manner without the user's attention. The cover 600 then determines the title and/or content of the booklet 650. In some embodiments, the cover 600 determines the title and/or content of the book 650 automatically (e.g. by scanning an RFID tag 662 using an embedded RFID reader 622). In some embodiments, the user inputs the booklet information (e.g. selects a booklet title from a list presented on the cover). Once the booklet 650 is detected, the user is able to use the cover 600 similar to the paper-based touch book 100. The user is able to press a location on a page, and the sensors in the cover 600 will determine where on the page and which page was pressed, and then play the corresponding audio clip. As described above, any number of implementations are able to be used to determine the page being pressed. In this embodiment, users are able to incorporate completely unmodified books with the cover 600 and receive an interactive experience.

### Talking Book With a Screen

In some embodiments, a cover or talking book is configured to receive a portable computing device (e.g., tablet or smart phone).

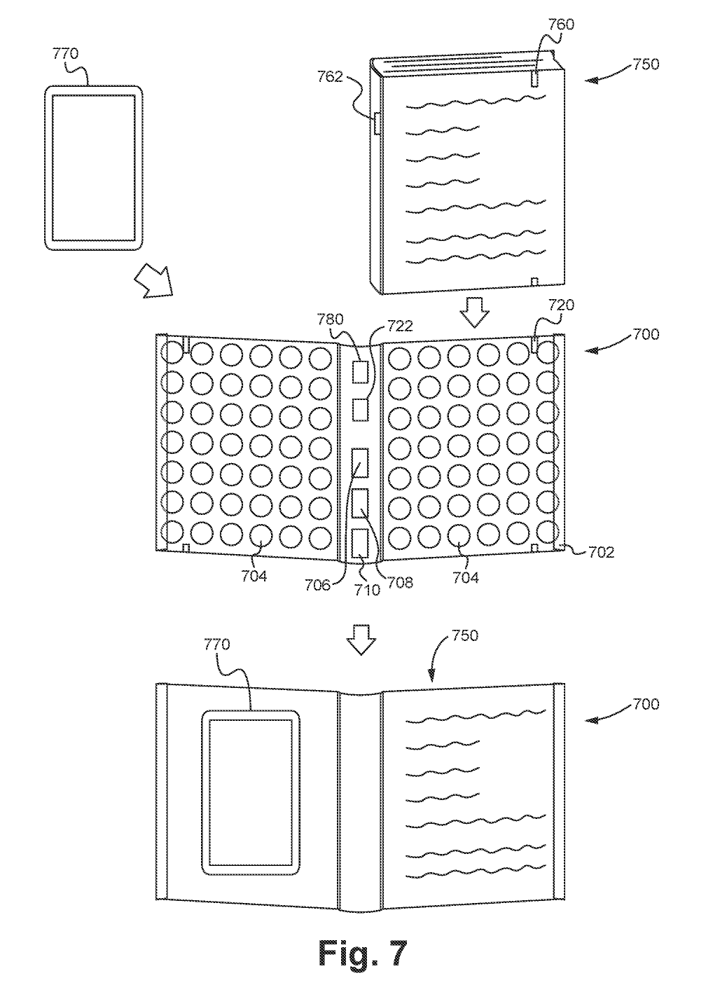

FIG. 7 illustrates a view of a talking book/cover with a screen according to some embodiments. A cover 700 includes similar components to the paper-based touch book 100 to enable playback of audio recordings in conjunction with viewing a book/booklet. In some embodiments, the cover 700 includes one or more sets of sensors 704, a microprocessing system 706, a response system 708, one or more speakers 710, and a portable computing device 770. In some embodiments, the cover 700 includes a front flap, a back flap and a binding between the two, similar to a standard hardcover book. In some embodiments, the cover 700 includes a folded edge 702 to help secure the book 750 in place. The cover 700 slides onto or receives a book 750, so that the user is able to read and receive audio information about the book 750. The cover 700 is used by sliding the cover 700 onto the book 750 or attaching the book 750 to the cover 700. The book 750 is able to be secured within the cover in any manner such as clips, sleeves, magnets or any other mechanism. For example, bringing the book into close proximity to the removable cover would cause a magnetic field to destabilize except in a specific location and alignment. In another example, metal clips 760 on the book 750 align with the magnets 720 in the cover 700. The effect is that the book would snatch into place and align correctly in a precise manner without the user's attention. The cover 700 then determines the title and/or content of the book 750. In some embodiments, the cover 700 determines the title and/or content of the book 750 automatically (e.g. by scanning an RFID tag 762 using an embedded RFID reader 722). In some embodiments, the user inputs the book information (e.g. selects a book title from a list presented on the cover). Once the book 750 is detected, the user is able to use the cover 700 similar to the paper-based touch book 100. The user is able to press a location on a page, and the sensors in the cover 700 will determine where on the page and which page was pressed, and then play the corresponding audio clip. As described above, any number of implementations are able to be used to determine the page being pressed. In this embodiment, users are able to incorporate completely unmodified books with the cover 700 and receive an interactive experience.

In some embodiments, the cover 700 includes a receiving component for receiving the portable computing device 770. For example, the cover 700 includes one or more magnets for holding the portable computing device 770 in place and/or a recessed pocket for receiving the portable computing device 770. Any other implementation for receiving and securing the portable computing device 770 is possible such as a clip, strap and/or corner pockets which receive the corners of the portable computing device 770. In some embodiments, the portable computing device 770 is removable, and in some embodiments, the portable computing device 770 is affixed to the cover 700. In some embodiments, the side of the cover 700 or book configured for receiving the portable computing device includes sensors, and in some embodiments, that side does not include sensors.

In some embodiments, the cover 700 includes different configurations of receiving a removable book 750. For example, the removable book 750 is able to be inserted into or placed on the cover 700 in a horizontal configuration or a vertical configuration. In some embodiments, the cover 700 includes an orientation sensor 780 (e.g., an accelerometer or other sensor) to determine which way the removable book 750 and/or the portable computing device 770 are oriented. For example, if the cover 700 is opened/positioned as a regular book, it is able to be determined that the removable book 750 is positioned as a regular book, and if the cover 700 is opened/positioned vertically, it is able to be determined that the removable book 750 is positioned accordingly. Determining the orientation also affects the sensors 704 of the cover 700. For example, if the book 750 is positioned horizontally, and the cover thinks the book 750 is positioned vertically, then the sensors 704 detecting a finger may indicate the wrong information to be played back. Thus, the orientation of the book 750 in the cover 700 determines which sensors indicate which information to be played back. In some embodiments, the orientation of the book 750 is determined in another manner such as based on the title of the book or other information acquired/read from the book. For example, the cover 700 stores a database of book titles or other identifying information, and in the database, it is also indicated if the book is sized/oriented to be positioned vertically (e.g., with the pages opening to the left) or horizontally (e.g., with the pages opening up) in the cover 700. In some embodiments, the orientation of the book is determined using the portable computing device 770 (e.g., an accelerometer in the portable computing device 770), and the orientation information is communicated to the cover 700, and cover 700 determines which information to play back based on the sensors 704 and the orientation. In some embodiments, it is assumed the portable computing device 770 and the book 750 have the same orientation (e.g., both vertical). In some embodiments, it is assumed the portable computing device 770 and the book 750 have a perpendicular orientation (e.g., one horizontal and one vertical). In some embodiments, a user is able to input the orientation (e.g., on the portable computing device 770, the cover 700, or both).

In some embodiments, the cover 700 and the portable computing device 770 are able to communicate (e.g., sync). In some embodiments, in addition to or instead of playing the audio using the speakers 710 in the cover 700, the portable computing device 700 plays the audio. For example, a sensor 704 is detected which causes a signal with information to be sent to the portable computing device 770 which uses the information to determine which information to be played back. Furthering the example, the portable computing device 770 includes an app that determines the book and uses the sensor information as an input to play an output. In some embodiments, other information, related or unrelated to the book, is provided based on the communication between the cover/book and the portable computing device 770 (e.g., based on the detected finger presses in the book/cover). For example, videos are played back, prizes are awarded when a user correctly answers a question, content is unlocked, games are available for play, similar content is made available for purchase, and/or any other interaction between the cover 700 and the portable computing device 770 is possible.

In some embodiments, the portable computing device 770 is used to sense the finger touches of the book 750. For example, the portable computing device 770 is on a first side of the inside of the cover 700, and the book 750 is on the second side of the inside of the cover, but when opened, the pages of the book 750 lay on top of the portable computing device 770. Using the touch screen capabilities of the portable computing device 770, the portable computing device 770 is able to detect where the user touches and play back audio. As described herein, the cover/book is able to communicate with the portable computing device 770 (e.g., inform the portable computing device 770 of the title, current page, and/or any other information). In some embodiments, an app stored on the portable computing device 770 is configured to detect touches and/or play content back and/or send the information to the cover 700.

In some embodiments, the cover 700 includes minimal components (e.g., sensors and a processing unit), and the portable computing device 770 includes an app and hardware to determine the book content, current page, and any other information about the book 750.

In some embodiments, the cover 700 includes two portable computing devices 770. For example, a first computing device is received on the inside of the front flap of the cover 700, and a second computing device is received on the inside of the back flap of the cover 700. The two portable computing devices 770 are able to be affixed, removable, or one is affixed and one is removable.

In some embodiments, the cover 700 is configured to receive the portable computing device 770 on the outside of the cover 700 (e.g. on the outside of the front and/or back flap).

There are a variety of configurations of the cover, book and/or portable computing device. The following are exemplary configurations and are not meant to limit the invention in any way:
1) talking book with affixed or removable computing device
2) talking cover with affixed or removable computing device
3) talking book with two computing devices (one or both are affixed or removable)
4) talking cover with two computing devices (one or both are affixed or removable)

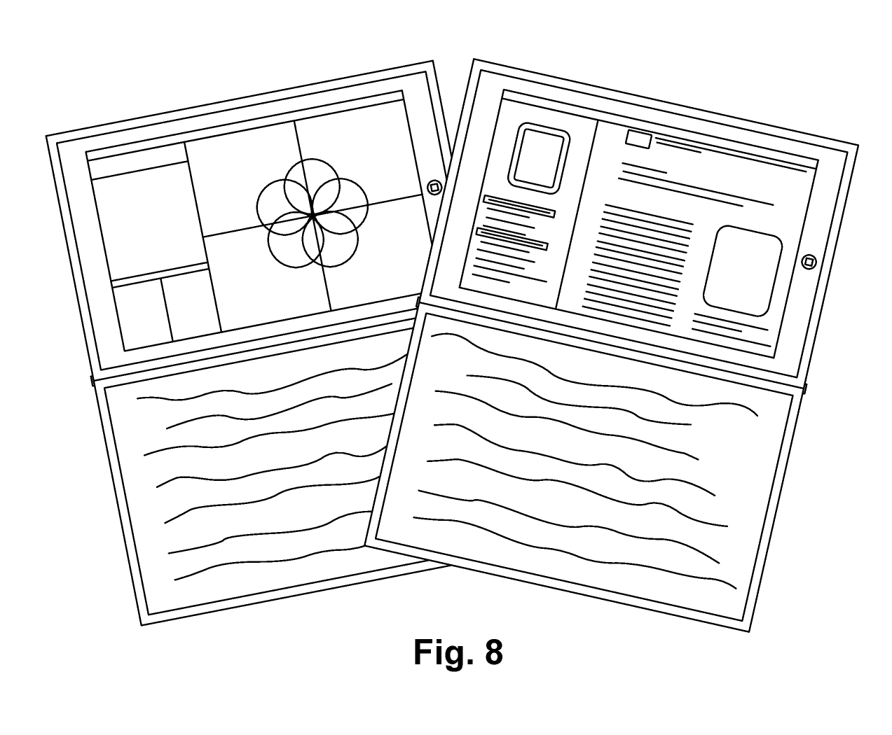

FIG. 8 illustrates an exemplary talking book/cover with a screen according to some embodiments.

### Talking Notebook

In some embodiments, a digital note taking device is implemented.

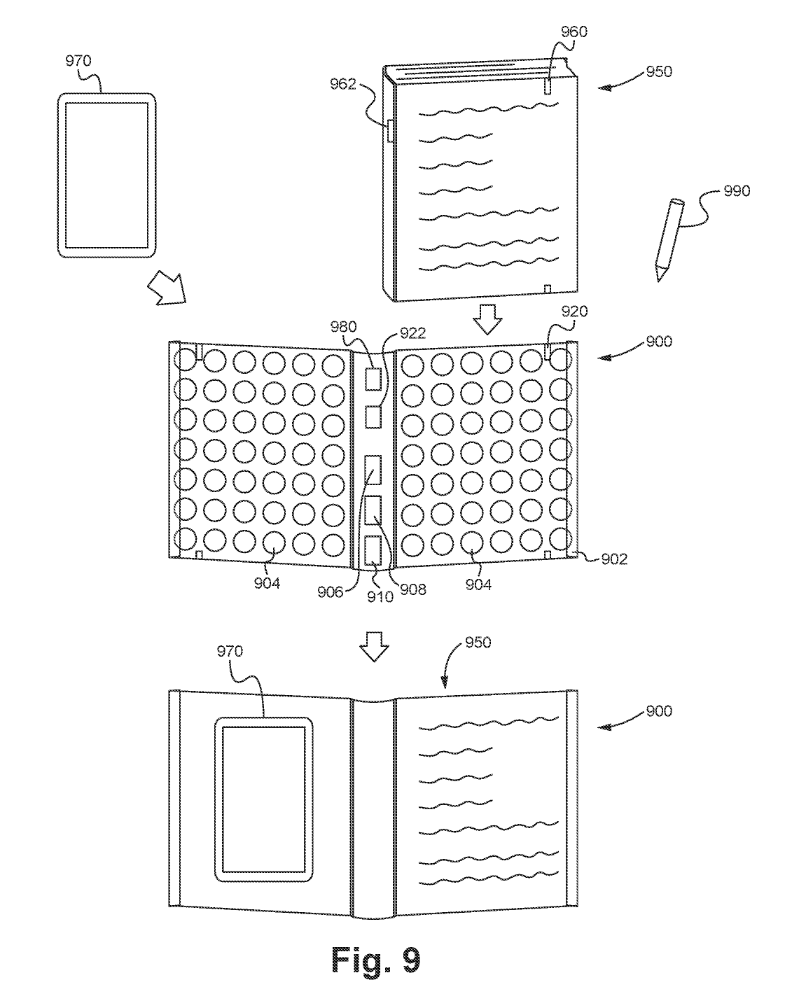

FIG. 9 illustrates a view of a talking notebook according to some embodiments. A cover 900 includes similar components to the paper-based touch book 100 to enable playback of audio recordings in conjunction with viewing and writing in a notebook or another book (e.g., textbook). The cover 900 includes one or more sets of sensors 904, a microprocessing system 906, a response system 908, one or more speakers 910, and a portable computing device 970. In some embodiments, the cover 900 includes a front flap, a back flap and a binding between the two, similar to a standard hardcover book. In some embodiments, the cover 900 includes a folded edge 902 to help secure a notebook 950 or another book (e.g., textbook) in place. The cover 900 slides onto or receives the notebook 950. The cover 900 is used by sliding the cover 900 onto the notebook 950 or attaching the notebook 950 to the cover 900. The notebook 950 is able to be secured within the cover 900 in any manner such as clips, sleeves, magnets or any other mechanism. For example, bringing the notebook 950 into close proximity to the cover 900 would cause a magnetic field to destabilize except in a specific location and alignment. In another example, metal clips 960 on the notebook 950 align with the magnets 920 in the cover 900. The effect is that the notebook 950 would snatch into place and align correctly in a precise manner without the user's attention. The cover 900 then determines the title and/or content of the notebook/textbook In some embodiments, the cover 900 determines the title and/or content of the notebook/textbook automatically (e.g. by scanning an RFID tag 962 using an embedded RFID reader 922). For example, a user has several notebooks, and each one as a distinct RFID tag 962, so that the cover 900 knows which notebook is placed within the cover 900. Similarly, textbooks are able to be placed in the cover which have an RFID tag 962 or are able to be identified in another manner. In some embodiments, the user inputs the book information (e.g. selects a book title from a list presented on the cover 900 or inputs that this is a notebook for Chemistry I). Once the notebook 950 (or textbook) is detected, the user is able to use the cover 900 similar to the paper-based touch book 100. The user is able to press a location on a page, and the sensors in the cover 900 will determine where on the page and which page was pressed. In some embodiments, the cover 900 will then play the corresponding audio clip. As described above, any number of implementations are able to be used to determine the page being pressed.

In some embodiments, the cover 900 includes a receiving component for receiving the portable computing device 970. For example, the cover 900 includes one or more magnets for holding the portable computing device 970 in place and/or a recessed pocket for receiving the portable computing device 970. Any other implementation for receiving and securing the portable computing device 970 is possible such as a clip, strap and/or corner pockets which receive the corners of the portable computing device 970. In some embodiments, the portable computing device 970 is removable, and in some embodiments, the portable computing device 970 is affixed to the cover 900.

In some embodiments, the cover 900 includes different configurations of receiving a removable notebook 950. For example, the removable notebook 950 is able to be inserted into or placed on the cover 900 in a horizontal configuration or a vertical configuration. In some embodiments, the cover 900 includes an orientation sensor 980 (e.g., an accelerometer or other sensor) to determine which way the removable notebook 950 and/or the portable computing device 970 are oriented. For example, if the cover 900 is opened/positioned in a portrait configuration, it is able to be determined that the removable notebook 950 is positioned in a portrait configuration, and if the cover 900 is opened/positioned in a landscape configuration, it is able to be determined that the removable notebook 950 is positioned accordingly. In some embodiments, the orientation of the notebook 950 is determined using the portable computing device 970 (e.g., an accelerometer in the portable computing device 970), and the orientation information is communicated to the cover 900. In some embodiments, it is assumed the portable computing device 970 and the notebook 950 have the same orientation (e.g., both vertical). In some embodiments, it is assumed the portable computing device 970 and the notebook 950 have a perpendicular orientation (e.g., one horizontal and one vertical. In some embodiments, a user is able to input the orientation (e.g., on the portable computing device 970, the cover 900, or both).

A smart pen 990 (e.g., a device that is able to write on paper while simultaneously recording/transmitting the same content in a digital format) is able to be used to write in the notebook 950. The smart pen 990 is configured to communicate with the portable computing device 970. While writing with the smart pen 990, the user is able to take physical written notes (e.g., using ink, graphite or a similar material) in the notebook 950 as well as digital notes in the portable computing device 970. In some embodiments, an app on the portable computing device 970 is able to acquire/determine the page number and/or location of the text, so that when the user or another user presses a sensor corresponding to the text, the appropriate text is read.

In addition to using the smart pen 990 to take notes in the notebook 950, the user is also able to complete homework. By using the smart pen 990 to take notes or do homework, the user is able to send a digital copy to his teacher, or the information is able to be directly streamed to the teacher. In some embodiments, the homework provided to the student is recognized (e.g., by the smart pen 990, the cover 900 and/or the portable computing device 970). For example, a bar code, QR code or other content is scanned, and based on that, a digital version is presented on the portable computing device 970. Then, when the user uses the smart pen 990 on the physical homework, the written information is digitized on the digital homework.

In some embodiments, the writing is able to be replayed as a colorful video on the portable computing device. For example, the colors of the content (e.g., foreground and/or background) change while the video is played. In another example, video content is displayed while the writing is played back.

In some embodiments, instead of a notebook 950 being placed in the cover 900, a textbook is able to be received by the cover 900. The user is able to acquire a physical textbook and a digital version of the textbook, where the digital version of the text book is stored on or is accessible by the portable computing device 970. In some embodiments, the cover 900 determines the textbook using the any of the methods described herein. In some embodiments, the cover 900 determines the book, the page the user is on, and/or other information, so that when the user takes notes in the physical book, the notes are also placed in the correct location in the digital version of the book on the portable computing device 970. For example, the cover 900 determines that the user placed a Chemistry I book in the cover 900, and the cover 900 also determines that the user is on page 234. The user takes notes in the Chemistry I book by writing on page 234 using the smart pen 990. Previously, the user acquired the digital verison of the Chemistry I book as well. Using software and hardware contained in the smart pen 990, cover 900 and/or portable computing device 970, the notes written on page 234 of the Chemistry I book are placed on page 234 of the digital version of the Chemistry I book accessible by the portable computing device 970. For example, the cover 900 determines that the book is a specific Chemistry I book using the RFID reader 922 and the page based on the page analysis described herein. The cover 900 communicates this information to the portable computing device 970 which retrieves an equivalent digital book (e.g., using a look-up table to match the physical book information with the digital book information), and opens the digital book to the same page. Then, when the user writes on the physical book, the smart pen 990 sends the information to the portable computing device 970 which records the information on the digital book, so that the digital and physical books are essentially synchronized. In some embodiments, the digitized notes are positioned in the same location on the digital page as the physically written notes. The position of the notes is able to be determined using the sensors 904 to determine where the smart pen 990 is being pressed on the page of the book in the cover 900.

In some embodiments, the cover 900 and the portable computing device 970 are able to communicate (e.g., sync). In some embodiments, in addition to or instead of playing the audio using the speakers 910 in the cover 900, the portable computing device 900 plays the audio. For example, a sensor 904 detects a touch which causes a signal with information to be sent to the portable computing device 970 which uses the information to determine which information to be played back. In some embodiments, other information, related or unrelated to the book, is provided based the communication between the cover/book and the portable computing device 970 (e.g., based on the detected finger presses in the book/cover). For example, videos are played back, prizes are awarded when a user correctly answers a question, content is unlocked, games are available for play, similar content is made available for purchase, and/or any other interaction between the cover 900 and the portable computing device 970 is possible.

In some embodiments, the portable computing device 970 is used to sense the finger touches of the textbook. For example, the portable computing device 970 is on a first side of the inside of the cover 900, and the textbook is on the second side of the inside of the cover, but when opened, the pages of the textbook lay on top of the portable computing device 970. Using the touch screen capabilities of the portable computing device 970, the portable computing device 970 is able to detect where the user touches and play back audio. As described herein, the cover is able to communicate with the portable computing device 970 (e.g., inform the portable computing device 970 of the title, current page, and/or any other information). In some embodiments, an app stored on the portable computing device 970 is configured to detect touches and send the information to the cover 900.

In some embodiments, the cover 900 includes minimal components, and the portable computing device 970 includes an app and hardware to determine the textbook content, current page, and any other information about the textbook.

In some embodiments, the cover 900 includes two portable computing devices 970. For example, a first computing device is received on the inside of the front flap of the cover 900 and a second computing device is received on the inside of the back flap of the cover 900. The two portable computing devices 970 are able to be affixed, removable, or one is affixed and one is removable.

In some embodiments, the cover 900 is configured to receive the portable computing device 970 on the outside of the cover 900 (e.g. on the outside of the front and/or back flap).

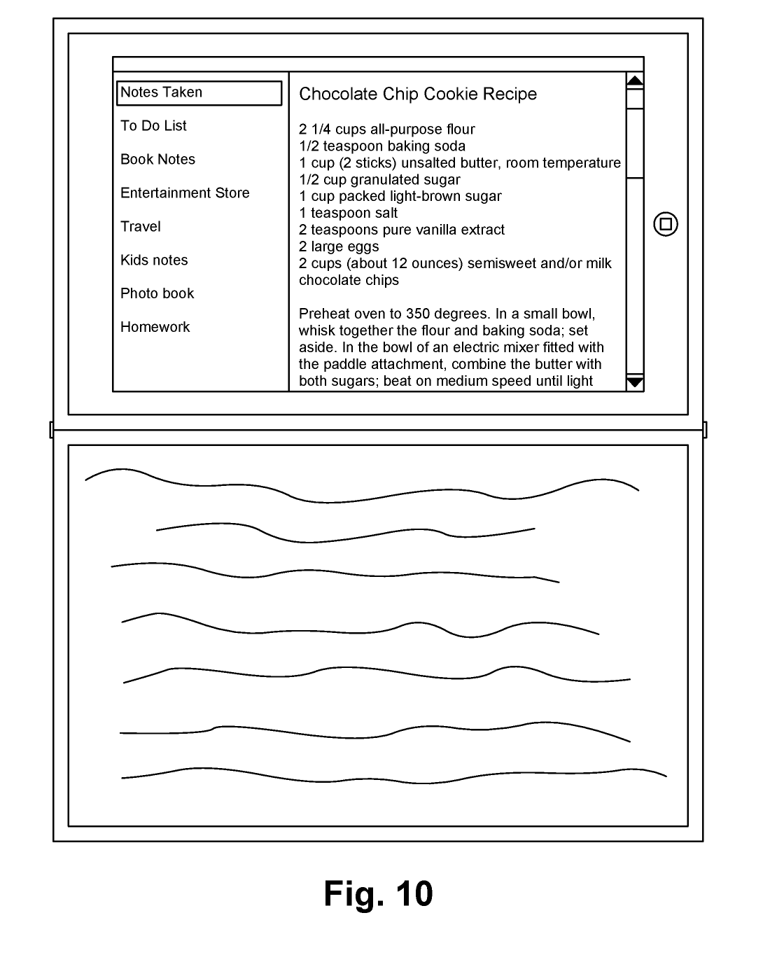

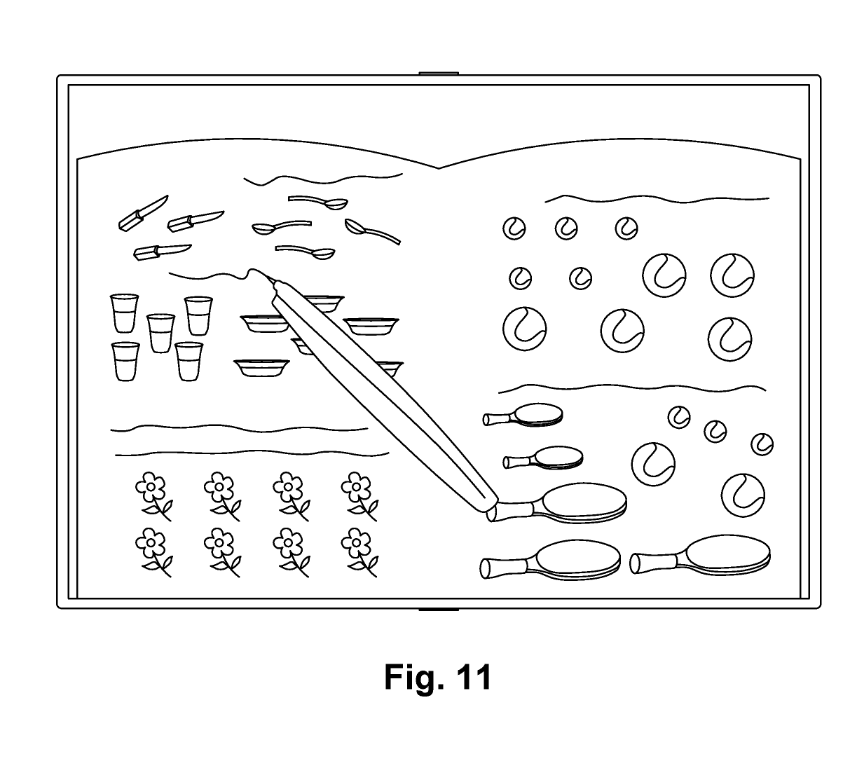

FIG. 10 illustrates an exemplary digital notebook according to some embodiments. FIG. 11 illustrates an exemplary digital note taking system with a textbook according to some embodiments.

In some embodiments, users are able to share, publish, or collaborate on their notes using the digital note taking system.

Talking Notebook with Projection

In some embodiments, a digital note taking device is able to be integrated with a digital classroom board.

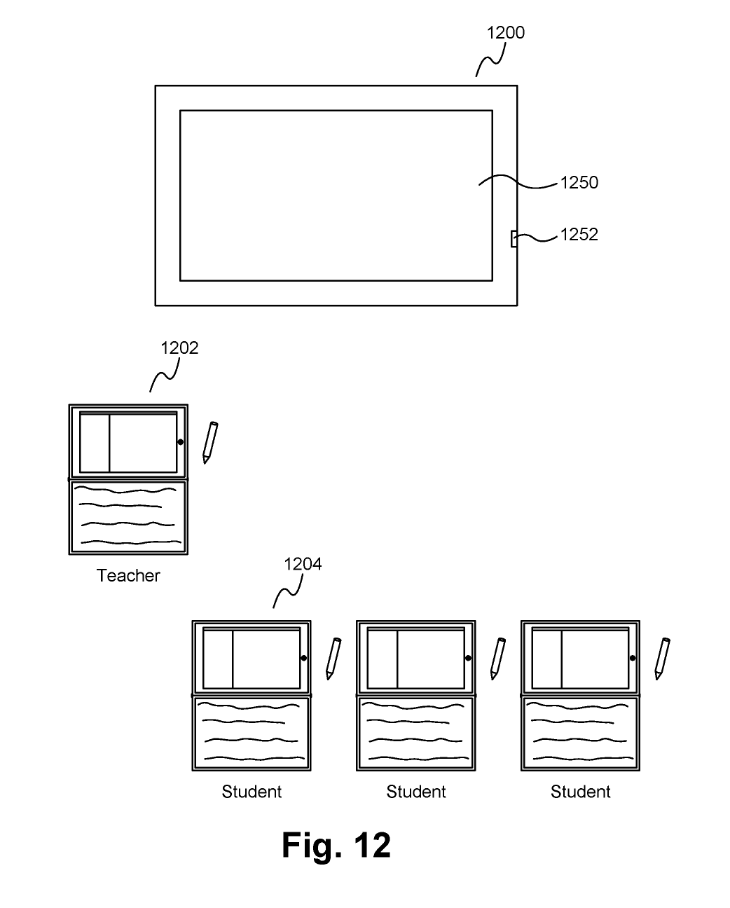

FIG. 12 illustrates a digital note taking device integrated with a digital classroom board according to some embodiments. The board 1200 is able to be any type of digital board or screen (e.g., a large tablet computer, a computer monitor, a smart television). In some embodiments, the board 1200 includes a transmitter/receiver 1252 (e.g., network card) configured for receiving digital notes stored on student devices 1204 and a display 1250 configured for displaying the digital notes. In some embodiments, the board 1200 stores access permissions (e.g., which devices are able to access the board 1200). For example, the access permissions are stored in a file which is modifiable using the teacher device 1202. In some embodiments, the board 1200 includes touch capabilities and/or any other capabilities of tablets, monitors and smart televisions. In some embodiments, user devices such as a teacher device 1202 and student devices 1204 are the same as or similar to the devices described herein (e.g., the digital note taking device of FIG. 9 with the cover 900, the notebook 950, the portable computing device 970, and the smart pen 990). In some embodiments, the teacher device 1202 and/or the student device 1204 are other devices such as a tablet computer, a smart phone, and/or another device. The teacher device 1202 communicates with the board 1200 to indicate what to display (e.g., display a video, display text, and/or pull content from another device such as a student device 1204). For example, the teacher device 1202 sends a command to the board 1200 which sends a command to a student device 1204 to retrieve a specific page of notes from the student device 1204. The teacher device 1202 is also able to communicate with the board 1200 and/or student devices 1204 to send information to the student devices 1204. For example, the teacher device 1202 sends a digital version of homework to the student devices 1204. In some embodiments, the teacher device 1202 communicates directly with the student devices 1204 to send information to the board 1200. For example, the teacher device 1202 sends a signal to the student device 1204 which then sends information (e.g., the student's notes) to the board 1200. In some embodiments, a command is able to be sent to all of the student devices 1204 at the same time to retrieve a specified content (e.g., document). For example, the teacher sends a command to retrieve all of last night's homework from each of the student devices 1204, and each student's homework is retrieved to the board 1200 for display to the class.

In some embodiments, the teacher is able to use the board 1200 to interact with the student devices 1204. For example, the board 1200 includes software and hardware capable of receiving input from a user's touch, smart pen or other input device as well as communicating with the student devices 1204 to send and receive information (e.g., pull a page of a student's digital notebook and display it on the board 1200).

In some embodiments, the students are able to interact with the board 1200 using a student device 1204. For example, the teacher asks a student to show how to draw a hexagon. Instead of having to go to the front of the classroom, the student operatively couples his student device 1204 to the board 1200 which displays his notes on his student device on the board 1200. The student then draws in his notebook of the student device with the smart pen, and the hexagon he draws is displayed on the board 1200. In some embodiments, the teacher, using the teacher device 1202 or the board 1200, enables a student 1202 to access the board 1200 before the student is able to display his notes on the board 1200. For example, the teacher is able to select a specific student's icon which unlocks access for the student device 1204.

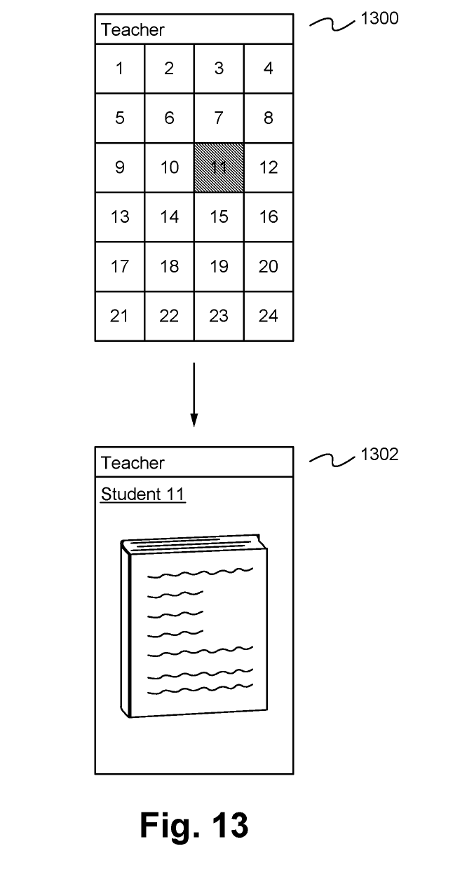

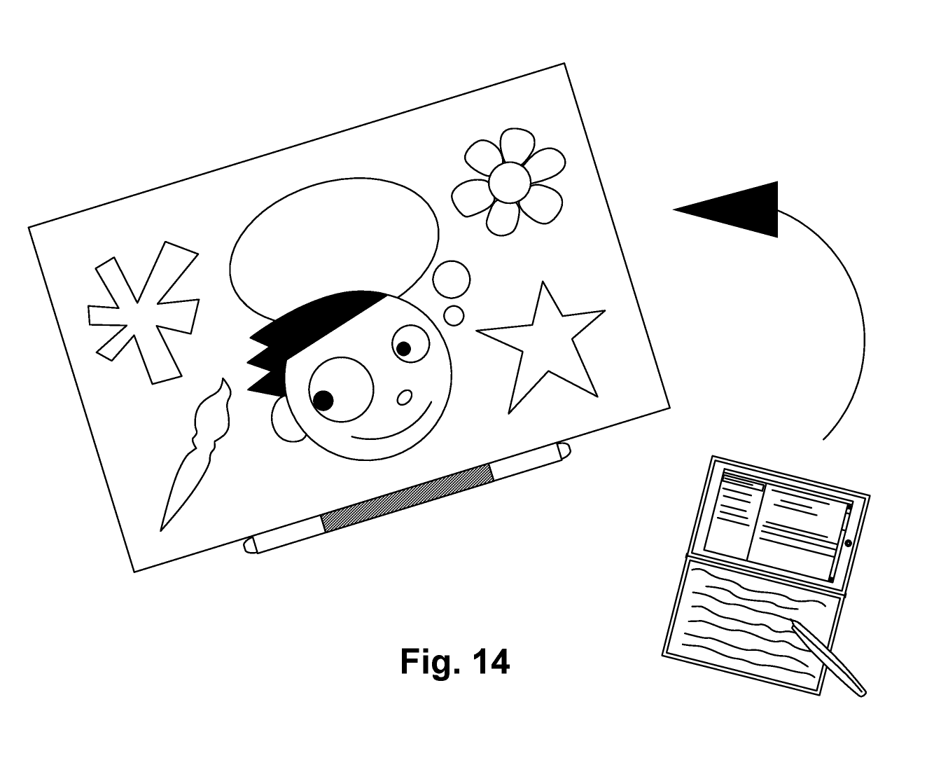

FIG. 13 illustrates a diagram of interacting with the board according to some embodiments. Using the board 1200 and/or the teacher device 1202, the teacher is able to view a layout 1300 of the students. The layout 1300 is able to be any configuration/format. In an example, images of the students' faces are displayed and are selectable. In the exemplary layout 1300, each student is numbered, so the teacher is able to select a number to view the notes and/or other content on that student's device. In the example, the teacher selects Student 11. After the selection, Student 11's notes 1302 are displayed. The teacher is able to swipe through the notes to the correct page that the teacher would like to display on the board 1200. Then, when the teacher selects the page, Student 11's notes are displayed on the board 1200 for the class to view. In some embodiments, Student 11's notes are automatically displayed on the board 1200 upon selection of the student's number, so the other students are able to see the swiping of the notes. In some embodiments, the teacher is able to add notes which go to the specific student's notes or to each of the students' notes. For example, the teacher writes a grade for Student 11's notes using the board 1200 or the teacher device 1202 which is sent to and saved in Student 11's notes. In another example, the teacher provides supplemental notes which are sent from the teacher device 1202 to the student devices 1204. In some embodiments, any notes (e.g., a grade) sent from the teacher device 1202 are locked in the student's notes, so that the student is not able to delete or modify them. In some embodiments, the teacher is able to select locked or unlocked (e.g., grades are locked, but supplemental notes are unlocked).

FIG. 14 illustrates an exemplary digital board according to some embodiments.

### Sensitivity Adjustment for Talking Book

In some embodiments, sensors for a talking book are adjusted to improve performance of the talking book.

Typically, capacitive sensors which sense the x, y coordinates of touches lose accuracy, precision and sensitivity (e.g., the amount of input one makes to activate the sensor) as more papers/thickness is between a user's touch and the sensors. In some embodiments, the capacitive sensors are able to detect a user's finger without the user's finger actually touching a page. For example, the capacitive sensors are configured to detect and measure proximity, position or displacement, and/or acceleration. Additionally, the accuracy and precision of the grid of sensors as a whole is affected regarding locating the touch. To enhance these factors, an algorithm is utilized to tune the parameters of the sensor such as capacitance or stiffness based on the number of pages between the user's finger and the sensors (e.g., determining the number of pages the user has flipped and subtracting that number from the total number of pages to determine the remaining number of pages). As a result, on page 1, the sensor will have less absolute sensitivity than on page 60, which results in the same effective sensitivity to the end user. Another algorithm takes the input of the grid as a whole, along with the expected behavior at the given page number, and does noise reduction to obtain a better signal.

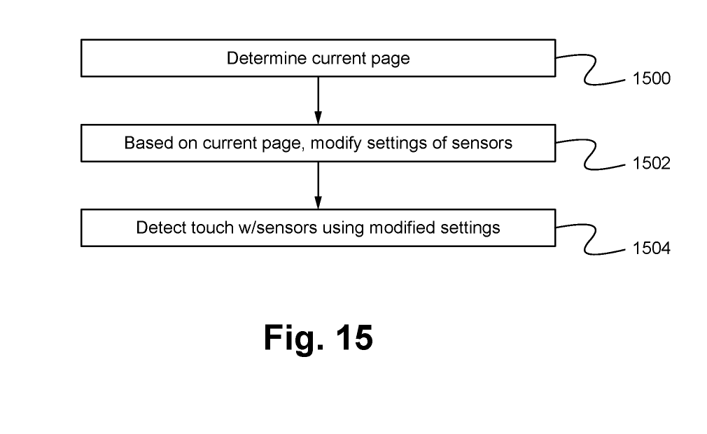

FIG. 15 illustrates a flowchart of a method of adjusting sensors of a talking book device according to some embodiments. In the step 1500, a current page of the book is determined. As described herein, the current page is able to be determined in any manner. In the step 1502, based on the current page, settings of the sensors of the book are modified. For example, the sensitivity, accuracy and/or precision of each individual sensor is able to be increased or decreased depending on the current page. For example, if the current page is page 1 of a 60-page book, then the sensitivity is increased, and if the current page is page 60 of a 60-page book, the sensitivity is decreased, so that the sensors have the same effective sensitivity. In some embodiments, a page in the middle of the book has no change in sensitivity, and as the page is farther from the middle, the sensitivity is increased or decreased. For example, a first page has the sensitivity increased the most, and the last page has the sensitivity decreased the most. In some embodiments, the sensitivity of the last page is not increased, and any page before that has increasing sensitivity such that the first page has the largest sensitivity increase. The accuracy and/or precision of the grid of sensors as a whole are also able to be increased or decreased depending on the current page. Settings of the sensors are able to be modified in any manner, such as modifying a variable within code related to the sensors stored in a memory and/or the embedded microprocessing system 114 (FIG. 1) of the book. For example, the programming code used by the book includes variables for settings which are dependent on the current page. Furthering the example, accuracy=x*sensor reading, where x is 1−(current page−1/total pages), so that when the current page is page 1, the variable x is 1, so the value of the sensor reading is not affected, but when the current page is page 60 (out of 60), then the sensor reading is significantly lessened. In some embodiments, the input of the grid of sensors as a whole is utilized along with the expected behavior at the given page number, and noise reduction is performed to obtain a better signal. In the step 1504, a touch is detected with sensors using the modified settings. In some embodiments, fewer or additional steps are implemented. For example, the additional steps of recognizing a book and playing back audio are implemented. In some embodiments, the order of the steps is modified.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system comprising:
a. a digital board configured for displaying content;
b. one or more student devices configured for communicating with the digital board; and
c. a teacher device configured for communicating with the digital board and the one or more student devices.

2. The system of claim 1 wherein the teacher device is configured to send a command to the digital board, and the digital board is configured to send a second command to the one or more student devices to retrieve a page of notes from the one or more student devices to the board.

3. The system of claim 1 wherein the teacher device is configured to send a command directly to the one or more student devices to retrieve a page of notes from the one or more student devices to the digital board.

4. The system of claim 1 wherein the teacher device is configured for pulling information from the one or more student devices and sending the information to the digital board.

5. The system of claim 1 wherein the one or more student devices are configured for sending and receiving the content to and from the digital board.

6. The system of claim 1 wherein the teacher device is configured to enable the one or more student devices to have access to the board.

7. The system of claim 1 wherein the teacher device displays icons representing the one or more student devices.

8. The system of claim 7 wherein each icon of the icons includes an image of a student.

9. The system of claim 1 wherein the teacher device is configured to send information to the one or more student devices.

10. The system of claim 9 wherein the information sent from the teacher device to the one or more student devices is locked so that a student is not able to edit the information.

11. The system of claim 1 wherein the one or more student devices each comprise:
i. a notebook;
ii. a portable computing device;
iii. a cover configured for receiving the notebook and the portable computing device; and
iv. a smart pen configured for writing physical content in the notebook and simultaneously sending information to the portable computing device so that digital content equivalent to the physical content is stored on the portable computing device.

12. A method of utilizing a digital board comprising:
a. accessing digital notes stored on one or more student devices using a teacher device; and
b. displaying the digital notes on a digital board.

13. The method of claim 12 further comprising sending a command from the teacher device to the digital board, and sending a second command to the one or more student devices to retrieve the digital notes from the one or more student devices to the board.

14. The method of claim 12 wherein further comprising sending a command directly from the teacher device to the one or more student devices to retrieve a page of notes from the one or more student devices to the digital board.

15. The method of claim 12 further comprising pulling information from the one or more student devices and sending the information to the digital board.

16. The method of claim 12 further comprising sending and receiving the content to and from the digital board using the one or more student devices.

17. The method of claim 12 further comprising enabling the one or more student devices to have access to the board.

18. The method of claim 12 further comprising sending information to the one or more student devices from the teacher device.

19. The method of claim 18 wherein the information sent from the teacher device to the one or more student devices is locked so that a student is not able to edit the information.

20. The method of claim 12 wherein the one or more student devices each comprise:
i. a notebook;
ii. a portable computing device;
iii. a cover configured for receiving the notebook and the portable computing device; and
iv. a smart pen configured for writing physical content in the notebook and simultaneously sending information to the portable computing device so that digital content equivalent to the physical content is stored on the portable computing device.

21. A device comprising:
a. a transmitter/receiver configured for receiving digital notes stored on one or more student devices; and
b. a display configured for displaying the digital notes.

22. The device of claim 21 wherein the transmitter/receiver is configured to receive a command from a teacher device and send a second command to the one or more student devices to retrieve the digital notes from the one or more student devices.

23. The device of claim 21 further comprising a mechanism to grant or deny access to the board.

24. The device of claim 21 wherein the one or more student devices each comprise:
i. a notebook;
ii. a portable computing device;
iii. a cover configured for receiving the notebook and the portable computing device; and
iv. a smart pen configured for writing physical content in the notebook and simultaneously sending information to the portable computing device so that digital content equivalent to the physical content is stored on the portable computing device.
